(19) United States
(12) Patent Application Publication
(10) Pub. No.: US 2016/0018583 A1
(43) Pub. Date: Jan. 21, 2016

(54) BACKLIGHT UNIT

(71) Applicant: SAMSUNG DISPLAY CO., LTD., YONGIN-CITY (KR)

(72) Inventors: Dong Hyeon LEE, Seoul (KR); Dong Hoon KIM, Gyeonggi-do (KR); Jin SEO, Gyeonggi-do (KR); Jun Woo YOU, Gyeonggi-do (KR); Lu Ly LEE, Gyeonggi-do (KR); Yeong Bae LEE, Gyeonggi-do (KR)

(21) Appl. No.: 14/628,449

(22) Filed: Feb. 23, 2015

(30) Foreign Application Priority Data
Jul. 16, 2014 (KR) 10-2014-0089449

(51) Int. Cl. F21V 8/00

(52) U.S. Cl. CPC G02B 6/0026; G02B 6/0073; G02B 6/0031; G02B 6/0088

(57) ABSTRACT

A backlight unit includes at least one light source configured to emit light and a light guide plate including a light incident surface and a light emitting emitting surface. The light from the light source is incident on the light incident surface and the incident light is emitted through the light emitting surface. A wavelength conversion unit is disposed between the light source and the light incident surface of the light guide plate. A lower cover is configured to cover at least part of a lower portion of a light incident surface of the wavelength conversion unit. An upper cover is configured to cover at least part of an upper portion of the light incident surface of the wavelength conversion unit.

### CROSS-REFERENCE TO RELATED APPLICATION

This application claims priority under 35 U.S.C. §119 to Korean Patent Application No. 10-2014-0089449, filed on Jul. 16, 2014, in the Korean Intellectual Property Office, the disclosure of which is incorporated by reference herein in its entirety.

### 1. TECHNICAL FIELD

Exemplary embodiments of the present inventive concept relate to a backlight unit which may reduce image defects.

### 2. DISCUSSION OF RELATED ART

Light-emitting diodes (LEDs) may be used as a light source in a backlight unit. The LED light source may emit blue light. The blue light may be converted to white light by wavelength-converting materials such as a phosphor. A backlight unit emitting white light may include a wavelength conversion unit disposed between a blue LED light source and a light guide plate.

### SUMMARY

Exemplary embodiments of the present inventive concept are directed toward a backlight unit which may reduce image defects.

According to an exemplary embodiment of the present inventive concept, a backlight unit includes at least one light source configured to emit light and a light guide plate having a light incident surface and a light emitting emitting surface. The light from the light source is incident on the light incident surface and the incident light is emitted through the light emitting surface. A wavelength conversion unit is disposed between the light source and the light incident surface of the light guide plate. A lower cover is configured to cover at least part of a lower portion of a light incident surface of the wavelength conversion unit. An upper cover is configured to cover at least part of an upper portion of the light incident surface of the wavelength conversion unit.

The lower cover may include first and second lower protrusions. A lower surface of the wavelength conversion unit may be disposed in a lower accommodating groove defined by the first and second lower protrusions.

At least one of the upper and lower covers may be configured to cover at least part of a light emitting surface of the wavelength conversion unit.

The wavelength conversion unit may include a glass container and a phosphor disposed in the glass container.

The phosphor may be disposed higher than the light source.

The phosphor may include a quantum dot.

The backlight unit may include a reflection member disposed between the lower accommodating groove and the wavelength conversion unit.

The reflection member may include a phosphor or silver (Ag).

The backlight unit may further include a cushion member disposed between the lower accommodating groove and the wavelength conversion unit.

The upper cover may include first and second upper protrusions. An upper surface of the wavelength conversion unit may be disposed in an upper accommodating groove defined by the first and second upper protrusions.

The backlight unit may further include a reflection member disposed between the upper accommodating groove and the wavelength conversion unit.

The reflection member may include a phosphor or silver (Ag).

The backlight unit may include a cushion member between the upper accommodating groove and the wavelength conversion unit.

The backlight unit may include a fixing part configured to fix at least one end portion of the wavelength conversion unit.

The backlight unit may include a mold frame configured to define a place in which the light guide plate and an optical sheet are installed. The mold frame may be coupled to the fixing part.

The fixing part may include a first fixing part having a first fixing groove in which a first side end portion of the wavelength conversion unit is disposed, and a second fixing part having a second fixing groove in which a second side end portion of the wavelength conversion unit is disposed. A fixing cover may be coupled to at least one end portion of the first and second fixing parts.

The fixing cover may face at least one side end portion of the wavelength conversion unit.

The lower cover may be integrated with the bottom chassis.

The upper cover may be integrated with the mold frame.

A location of a central axis of the wavelength conversion unit may be different from a location of an alignment line that connects a point of the light source with a central portion of the light incident surface of the light guide plate.

First, a coupling process of the wavelength conversion unit and the upper cover may be relatively simple and the time for assembly may be reduced.

The lower and upper covers may be integrated with the bottom chassis and the mold frame, respectively.

Friction between the wavelength conversion unit and the upper cover may be reduced in a coupling process of the wavelength conversion unit, and damage to the wavelength conversion unit may be reduced.

The upper and lower covers may cover the wavelength conversion unit and may be coupled to a surface of the wavelength conversion unit, and light loss may be reduced.

Light leakage may be reduced by the reflection member mounted on inner walls of upper and lower accommodating grooves.

First and second spacer walls may be disposed at an edge portion of a light guide plate, but not on a light incident surface of the light guide plate, and image degradation may be reduced.

An imaginary central line connecting a point of the light source with a central portion of the light incident surface of the light guide plate need not be consistent with a central portion of the light incident surface of the wavelength conversion unit, and light leakage may be reduced when using only one reflection member.

The cushion member may be disposed on inner walls of the upper and lower accommodating grooves, and adhesion between the wavelength conversion unit and a corresponding accommodating groove may be increased, mobility of the wavelength conversion unit may be reduced, and damage to the wavelength conversion unit may be reduced.

The foregoing summary is illustrative only and is not intended to be in any way limiting the exemplary embodiments of the present inventive concept. In addition to the exemplary embodiments described above, further aspects of the present inventive concept will become more apparent by reference to the drawings and the following detailed description.

### BRIEF DESCRIPTION OF THE DRAWINGS

FIG. 1 is an exploded perspective view illustrating a display device including a backlight unit according to an exemplary embodiment of the present inventive concept.

FIG. 2 is a cross-sectional view taken along line of FIG. 1.

FIG. 3 is a perspective view illustrating a wavelength conversion unit according to an exemplary embodiment of the present inventive concept.

FIG. 4 is a detailed view illustrating a lower cover illustrated in FIGS. 1 and 2.

FIG. 5 is a diagram illustrating a rear surface of a mold frame including an upper cover illustrated in FIGS. 1 and 2.

FIG. 6 is a diagram illustrating a reflection member in a lower cover.

FIG. 7 is a diagram illustrating a reflection member in an upper cover.

FIGS. 8A to 8F are diagrams illustrating an assembly process of a backlight unit according to an exemplary embodiment of the present inventive concept.

FIG. 9 is a diagram illustrating a lower cover integrated with on a bottom chassis.

FIG. 10 is a diagram illustrating a change of a location in which a wavelength conversion unit is disposed.

### DETAILED DESCRIPTION

Exemplary embodiments of the present inventive concept will be described below in more detail with reference to the accompanying drawings. The exemplary embodiments of the present inventive concept may, however, be embodied in many different forms and should not be construed as being limited to the embodiments set forth herein. Like reference numerals may refer to like elements throughout the specification and drawings.

Spatially relative terms “below”, “beneath”, “lower”, “above”, “upper”, and the like, may be used to describe the relationship between one element or component and another element or component as illustrated in the drawings. It will be understood that spatially relative terms may encompass different orientations of the device in use or operation, in addition to the orientation depicted in the drawings. For example, in the case where a device shown in the drawing is turned over, the device positioned “below” or “beneath” another device may be placed “above” another device. Accordingly, the illustrative term “below” may include both the lower and upper positions.

Throughout the specification and drawings, when an element is referred to as being “connected” to another element, the element may be “directly connected” to the other element, or “electrically connected” to the other element with one or more intervening elements interposed therebetween.

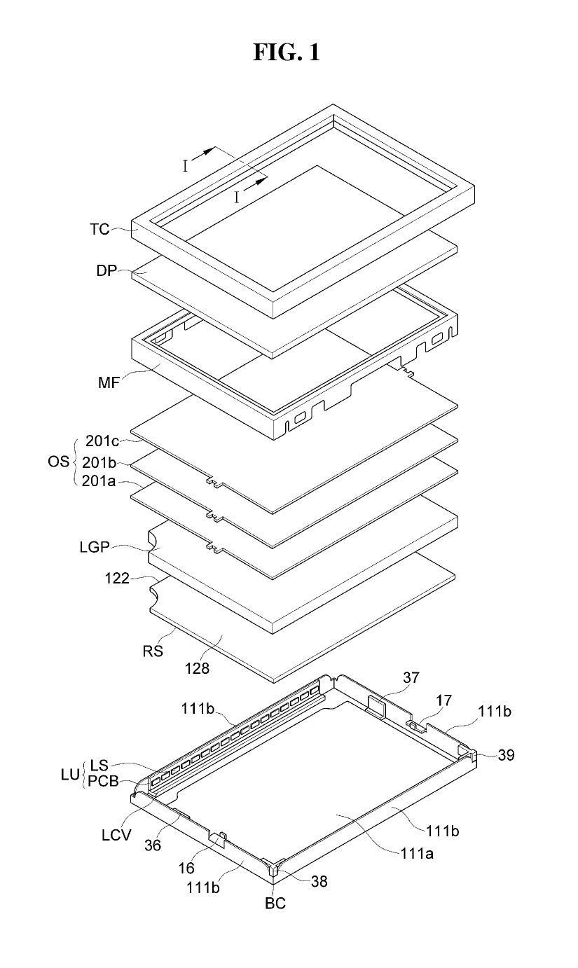

Hereinafter, a backlight unit according to an exemplary embodiment of the present inventive concept will be more fully described with reference to FIGS. 1 to 10.

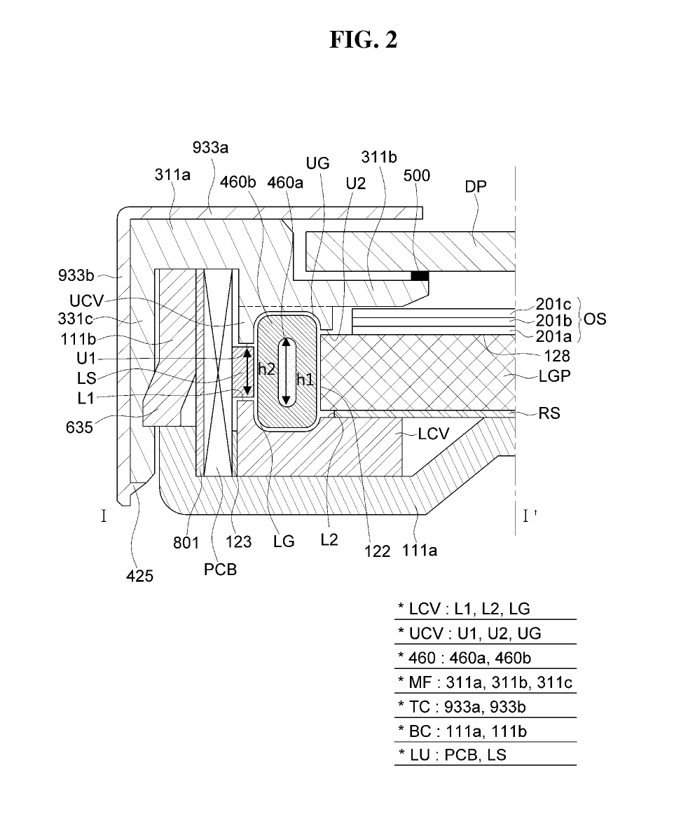

FIG. 1 is an exploded perspective view illustrating a display device including a backlight unit according to an exemplary embodiment of the present inventive concept. FIG. 2 is a cross-sectional view taken along line I-I′ of FIG. 1.

Referring to FIGS. 1 and 2, a display device according to an exemplary embodiment of the present inventive concept may include a bottom chassis BC, a lower cover LCV, a reflection sheet RS, a light guide plate LGP, an optical sheet OS, a light source unit LU, a mold frame MF, an upper cover UCV illustrated in FIG. 2, a display panel DP, and a top chassis TC. The lower cover LCV, the reflection sheet RS, the light guide plate LGP, the optical sheet OS, the light source unit LU, the mold frame MF, and the upper cover UCV may be included in a backlight unit according to an exemplary embodiment of the present inventive concept. The display panel DP and the backlight unit may be disposed in a laminate structure and may be included in a display module. The display module may include the top chassis TC and the bottom chassis BC, which may protect the display panel DP and the backlight unit and fix the display panel DP and the backlight unit in a position, and a driver circuit board configured to drive the display panel DP.

The display panel DP may display an image. The display panel DP may be substantially divided into two areas: a display area and a non-display area. The display area may display an image and the non-display area may include signal lines that transmit image data for image display, and control signals and power signals. The non-display area or the driver circuit board may include one or more driver circuit units providing image data, control signals and power signals.

The display panel DP may be a liquid crystal display (LCD) panel, but exemplary embodiments of the present inventive concept are not limited thereto. The display panel DP may be any panel structure capable of displaying an image by receiving light from the backlight unit.

The bottom chassis BC may include an accommodating space. The accommodating space may include the lower cover LCV, a wavelength conversion unit 460, the upper cover UCV, the reflection sheet RS, the light guide plate LGP, the optical sheet OS, and the light source unit LU. The bottom chassis BC may include a base portion 111a and a plurality of side portions 111b. In an exemplary embodiment of the present inventive concept, the base portion 111a may have a quadrangular shape and each of the plurality of side portions 111b may protrude from each edge portion of the base portion 111a to a predetermined height. Edge portions of the adjacent side portions 111b may be coupled to each other or may be separated from each other. The accommodating space may be a space defined by being surrounded by the side portions 111b and the base portion 111a.

A locking projection 635 may be disposed on an outside of the side portions 111b and the mold frame MF may be fixed to the bottom chassis BC by the locking projection 635. The locking projection 635 may be bent such that part of the corresponding side portion 111b may protrude toward the mold frame MF. The locking projection 635 may be disposed in a coupling groove in the mold frame MF. In an exemplary embodiment of the present inventive concept, the mold frame MF may be coupled to the bottom chassis BC using screws. The mold frame MF and the bottom chassis 440 may be coupled to each other in a variety of forms.

The accommodating space may include first to fourth supports 36, 37, 38, and 39. The first to fourth supports 36, 37, 38, and 39 may be disposed on side edge portions and side vertices of the bottom chassis BC. The first to fourth supports 36, 37, 38, and 39 may prevent the reflection sheet RS, the light guide plate LGP, a diffusion sheet 201a, a prism sheet 201b, and a protective sheet 201c from bending downward. The first to fourth supports 36, 37, 38, and 39 may restrict movement of the reflection sheet RS, the light guide plate LGP, the diffusion sheet 201a, the prism sheet 201b, and the protective sheet 201c so that these components may be stably disposed. The first to fourth supports 36, 37, 38, and 39 may include two projections that are disposed at different heights. The side edge portions and vertices of the bottom chassis BC may be disposed on the projection that is relatively lower between the two projections and that is disposed on an inner side of the bottom chassis BC. Movements of the side edge portions and vertices of the bottom chassis BC may be restricted by the other projection that is relatively higher between the two projections and that is disposed on an outside of the bottom chassis BC.

Side edge portions of the diffusion sheet 201a, the prism sheet 201b, and the protective sheet 201c may be supported by fifth and sixth supports 16 and 17. The fifth and sixth supports 16 and 17 may be bent at sides of the bottom chassis BC toward an inner side of the bottom chassis BC and may support the diffusion sheet 201a, the prism sheet 201b, and the protective sheet 201c. Side protrusions 44 and 45 may be disposed on two side edge portions of the diffusion sheet 201a, the prism sheet 201b, and the protective sheet 201c, and the side protrusions 44 and 45 may protrude towards the fifth and sixth supports 16 and 17 and may be disposed on the fifth and sixth supports 16 and 17.

The light source unit LU may produce light. As illustrated in FIG. 1, the light source unit LU may be disposed in the bottom chassis BC and may face a side (e.g., a light incident surface) of the light guide plate LGP. The light source unit LU may be disposed on an inner surface of the side portion of the bottom chassis BC. A plurality of light source units LUs may be disposed on the bottom chassis BC, and the number of light source units LUs may be determined according to the size and luminance uniformity of the display panel DP. Additional light source units LUs corresponding to other sides of the light guide plate LGP may be disposed at other side portions 111b of the bottom chassis BC.

As illustrated in FIGS. 1 and 2, the light source unit LU may include a printed circuit board PCB and at least one light source LS.

Although not illustrated, a surface of the printed circuit board PCB may be partitioned into at least one mounting area and a conductive line area. When the light source unit includes two or more light sources LS, one light source may be disposed in each mounting area and a plurality of conductive lines may be disposed in the conductive line area and may transmit drive power to the light sources. The drive power may be generated in an external power supply unit (not shown) and may be transmitted to the plurality of conductive lines through a separate connector (not shown). The printed circuit board PCB may include a metal material and heat produced by the light source LS may be transmitted to an outside of the backlight unit.

An adhesive member 801 may be disposed between a surface of the printed circuit board PCB and the side portion of the bottom chassis BC. The light source unit LU may be coupled to the bottom chassis BC by the adhesive member 801. The adhesive member 801 may be a double-sided tape and may be disposed between the light source unit LU and the printed circuit board PCB.

Although not illustrated, a heat sink may be disposed between the printed circuit board PCB and the adhesive member 801 and between the adhesive member 801 and the side portion 111B of the bottom chassis BC.

The light source LS may be driven by drive power to emit light. The light source LS may be disposed on the printed circuit board PCB. The light source LS may be an emission package including at least one light emitting diode (LED). For instance, the emission package may include a blue LED that emits blue light. Light emitted from the light source LS may be radiated onto the light guide plate LGP through the wavelength conversion unit 460.

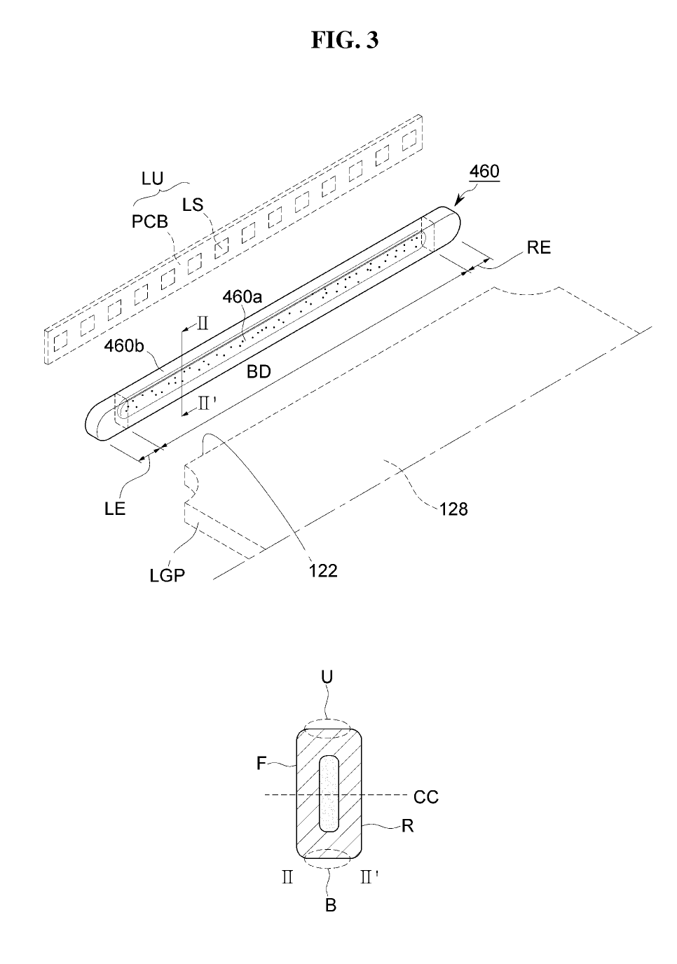

The wavelength conversion unit 460 may be disposed between the light source LS and the light guide plate LGP. In an exemplary embodiment of the present inventive concept, the wavelength conversion unit 460 may be disposed between an emission part of the light source LS and a light incident surface 122 of the light guide plate LGP. The configuration of the wavelength conversion unit 460 may be described in more detail with reference to FIG. 3.

FIG. 3 is a perspective view illustrating the wavelength conversion unit 460.

The wavelength conversion unit 460 may be configured to convert light produced by the light source LS, for example, to convert blue light to white light. As illustrated in FIG. 3, the wavelength conversion unit 460 may include a glass container 460b and a phosphor 460a in the glass container 460b. The glass container 460b may be sealed while including the phosphor 460a, thereby reducing penetration of moisture into the inside of the glass container 460b. The glass container 460b may have a shape of a bar and may have a polygonal or oval cross-section.

The phosphor 460a may be a substance that converts a wavelength of light. For example, the phosphor 460a may convert the wavelength of blue light emitted from a blue LED into white light.

The phosphor 460a may include quantum dots. The phosphor 460a may include at least one metal element. The metal element may be sulfide, silicon, or nitride.

The quantum dots may convert the wavelengths of light to emit desired colors of light. The quantum dots may convert different wavelengths of light depending on the size of the quantum dots. A diameter of the quantum dots may be adjusted according to a desired color of light.

The phosphor 460a may include a green conversion particle and a red conversion particle that include the quantum dots. The green conversion particle may have a smaller diameter than the red conversion particle.

The quantum dots may emit relatively stronger fluorescent light in a narrow wavelength range than a general fluorescent material, and the core of the quantum dots may include II-VI semiconductor nanocrystals such as CdSe, CdTe, or CdS.

For example, the quantum dots may have a diameter of about 2 nm to about 10 nm, and the size thereof may be adjusted as desired.

When the quantum dots have a relatively small diameter, the wavelength of emitted light may become shorter such that blue light may be produced. When the quantum dots have a relatively large diameter, the wavelength of emitted light may become longer such that red light may be produced.

The quantum dots may have a dual structure including an inner core and an outer shell surrounding the inner core. For instance, a CdSe/ZnS quantum dot may include an inner core made of CdSe and an outer shell made of ZnS.

Light wavelength conversion by the quantum dots will be described below in more detail. For example, when light emitted from the blue LED light source passes through the quantum dots, light passing through a relatively small-sized quantum dot may be converted to green light, light passing through a relatively large-sized quantum dot may be converted to red light, and light traveling between the quantum dots may remain unchanged as blue light. The red, green, and blue light may be mixed and white light may be produced. The relatively small-sized quantum dots may be the green conversion particle, and the relatively large-sized quantum dots may be the red conversion particle.

As illustrated in FIG. 3, the wavelength conversion unit 460 including the phosphor 460a may be divided into a body BD including the phosphor 460a, a left edge part LE disposed on a left side end portion of the body BD, and a right edge part RE disposed at a right side edge portion of the body BD. The body BD of the wavelength conversion unit 460 may include a light incident surface F, a light emitting surface R, an upper surface U, and a lower surface B. The light incident surface F of the wavelength conversion unit 460 may face the light source LS and may include rounded edge portions under and over the light incident surface F. Hereinafter, the rounded edge portion under the light incident surface F may be referred to as a first lower edge portion and the rounded edge portion over the light incident surface F may be referred to as a first upper edge portion.

The light emitting surface R of the wavelength conversion unit 460 may face the light incident surface 122 of the light guide plate LGP and may include rounded edge portions disposed under and over the light emitting surface R. Hereinafter, the rounded edge portion under the light emitting surface R may be referred to as a second lower edge portion and the rounded edge portion over the light emitting surface R may be referred to as a second upper edge portion.

The upper surface U of the wavelength conversion unit 460 may be disposed between the first upper edge portion and the second upper edge portion, and the lower surface B of the wavelength conversion unit 460 may be disposed between the first lower edge portion and the second lower edge portion.

As illustrated in FIG. 2, the height h1 of the phosphor 460a may differ from the height h2 of the light source LS. In an exemplary embodiment of the present inventive concept, a top of the phosphor 460a may be higher than a top of the light source LS.

The light guide plate LGP may be configured to guide light produced by the light source LS to the display panel DR The light guide plate LOP may supply light received from the light source LS to substantially the entire surface of the display area of the display panel DR As illustrated in FIGS. 1 and 2, the light guide plate LOP may have a shape of polyhedron. Among a plurality of surfaces of the light guide plate LOP, the surface facing the light source LS may be the light incident surface 122 and among the plurality of surfaces of the light guide plate LGP, the surface facing the display panel DP may be the light emitting surface. Light emitted from the light source LS may pass through the wavelength conversion unit 460 and may be transmitted onto the light incident surface 122. The transmitted light may propagate inside the light guide plate LGP. The light guide plate LGP may reflect the light propagating inside the light guide plate LGP and the reflected light may be totally internally reflected and may be emitted outwards through a light emitting surface 128. The light emitted outwards through the light emitting surface 128 may be transmitted through the optical sheet OS and may be transmitted to the display area of the display panel DR Although not illustrated, a plurality of scattering patterns may be disposed on a lower outside surface of the light guide plate LGP and may increase reflectivity of the light guide plate LGP. The distance between the scattering patterns may become larger as the scattering patterns are disposed farther from the light incident surface 122 of the light guide plate LGP.

The light guide plate LGP may include a light-transmissive material, for example, an acrylic resin such as polymethylmethacrylate (PMMA) or polycarbonate (PC), which may guide light.

The reflection sheet RS may be disposed under the light guide plate LGP. The reflection sheet RS may reflect light passing through the lower outside surface of the light guide plate LGP and emitted outwards back into the light guide plate LGP, thereby reducing or minimizing light loss. The reflection sheet RS may include, for example, polyethylene terephthalate (PET) which may impart reflective properties, and a surface of the reflection sheet RS may include a diffusion layer containing, for example, titanium dioxide. The reflection sheet RS may include a material containing a metal such as silver (Ag).

As illustrated in FIGS. 1 and 2, the optical sheet OS may be disposed between the light guide plate LGP and the display panel DP, and may diffuse and condense light transmitted from the light guide plate LGP. The optical sheet OS may include the diffusion sheet 201a, the prism sheet 201b, and the protective sheet 201c. The diffusion sheet 201a, prism sheet 201b, and protective sheet 201c may be sequentially disposed on the light guide plate LGP.

The diffusion sheet 201a may diffuse light received from the light guide plate LGP and may prevent light from being partially concentrated.

The prism sheet 201b may be disposed on the diffusion sheet 201a and may condense light diffused by the diffusion sheet 201a in a direction perpendicular to the display panel DR The prism sheet 201b may include triangular prisms on a surface thereof in a predetermined arrangement.

The protective sheet 201c may be disposed on the prism sheet 201b and may protect a surface of the prism sheet 201b and diffuse light to obtain substantially uniformly distributed light. Light passing through the protective sheet 201c may be transmitted to the display panel DP.

The lower cover LCV may cover part of a lower side of the wavelength conversion unit 460 and the configuration of the lower cover LCV may be described in more detail below with reference to FIGS. 2 to 4.

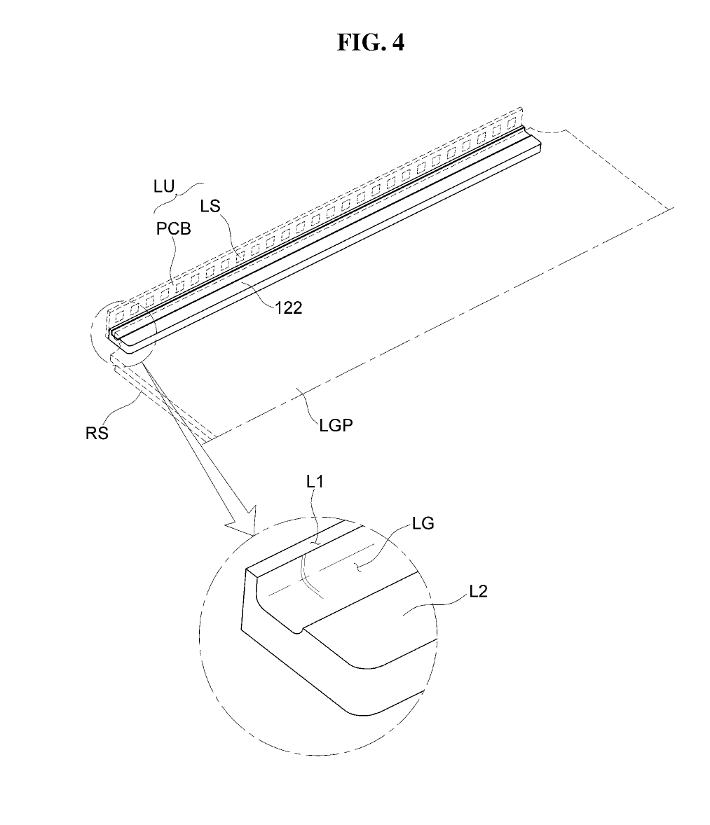

FIG. 4 is a detailed view illustrating the lower cover LCV illustrated in FIGS. 1 and 2.

As illustrated in FIG. 2, the lower cover LCV may cover part of a lower side of the light incident surface F of the wavelength conversion unit 460. The lower side of the light incident surface F may be disposed lower than a central portion CC of the light incident surface F. The lower side of the light incident surface F may refer to part of the light incident surface F included between the central portion CC of the light incident surface F and a lower boundary portion. The lower boundary portion may refer to a boundary between the light incident surface F and the lower surface B. Part of the lower side of the light incident surface F may refer to part of the lower side. In an exemplary embodiment of the present inventive concept, the part of the lower side may be the first lower edge portion.

As illustrated in FIGS. 2 to 4, the lower cover LCV may include a first lower protrusion L1 and a second lower protrusion L2, which may define a lower accommodating groove LG. The lower accommodating groove LG may be formed between the first and second lower protrusions L1 and L2, which may face each other.

Part of the lower side and the lower surface B of the light incident surface F of the wavelength conversion unit 460 may be disposed in the lower accommodating groove LG, and thus the part of the lower side may be covered with an inner wall of the lower accommodating groove LG. The inner wall of the lower accommodating groove LG may include surfaces of the first and second lower protrusions L1 and L2, which may face each other. As illustrated in FIG. 2, the inner wall of the lower accommodating groove LG may be disposed between the first and second lower protrusions L1 and L2, and may include a surface connecting the first and second lower protrusions L1 and L2 to each other.

Referring to FIGS. 2 and 3, the first lower edge portion of the light incident surface F may be covered with the inner wall of the lower accommodating groove LG. A partial surface adjacent to the first lower edge portion and disposed between the first lower edge portion and the central portion CC may be covered with the inner wall of the lower accommodating groove LG. The inner wall covering the first lower edge portion may have a rounded shape, and the rounded shape may be similar to a shape of the first lower edge portion. The first lower edge portion and the partial surface may all belong to the lower side of the light incident surface F.

Referring to FIG. 2, the second lower edge portion of the lower surface B and the light emitting surface R may be covered with the inner wall of the lower accommodating groove LG. A partial surface adjacent to the second lower edge portion of the light emitting surface R and disposed between the second lower edge portion and the central portion CC may be covered with the inner wall of the lower accommodating groove LG. The portions covered with the inner wall of the lower accommodating groove LG may be in contact with the inner wall.

The lower cover LCV, as illustrated in FIG. 2, for example, may be disposed on the base portion 111a of the bottom chassis BC. The base portion 111a may include an edge portion and a central portion, which may have different heights from each other. The lower cover LCV may be disposed in the edge portion that is relatively lower in height.

An edge portion of the reflection sheet RS may be disposed on the second lower protrusion L2 of the lower cover LCV and the second lower protrusion L2 may have the same height as the central portion of the base portion 111a. A central portion of the reflection sheet RS may be disposed on the central portion of the base portion 111a.

Although not illustrated, the second lower protrusion L2 may include two projections having different heights from each other. An edge portion of the light guide plate LGP may be disposed on the relatively taller projection and the edge portion of the reflection sheet RS may be disposed on the relatively shorter projection.

As illustrated in FIG. 2, an adhesive member 123 may be disposed between a surface of the printed circuit board PCB and the lower cover LCV. The lower cover LCV may be coupled to the printed circuit board PCB by the adhesive member 123. Although not illustrated, a heat sink may be disposed between the printed circuit board PCB and the adhesive member 123 and between the adhesive member 123 and the lower cover LCV.

The mold frame MF may fix the display panel DP and the top chassis TC while being fixed to the bottom chassis BC. The mold frame MF may be configured to maintain a constant distance between the display panel DP and the optical sheet OS. The mold frame MF may have a shape of a quadrangular frame including a first support 311a, a second support 311b, and a fixing member 311c.

The first support 311a may be configured to support the top chassis TC portion that covers the first support 311a, and the first support 311a may be disposed on a plurality of side portions 111b.

The second support 311b may extend from an inner edge portion of the first support 311a towards the optical sheet OS. The second support 311b may be shorter than the first support 311a. The difference in height between the first and second supports 311a and 311b may form a space between the top chassis TC and the second support 311b and an edge portion of the display panel DP may be disposed in the space. A cushion pad 500 protruding from an end portion of the second support 311b towards the display panel DP may be disposed at the end portion of the second support 311b, and an edge portion of the display panel DP may be disposed on the cushion pad 500. The cushion pad 500 may prevent direct contact between the display panel DP and the second support 311b, and may reduce scratches from occurring on the display panel DP.

The top chassis TC may be in the shape of a quadrangular frame that covers only an edge portion (e.g., the non-display area) of the display panel DP on the front surface thereof. The top chassis TC may cover an upper surface and a side surface of the first support 311a of the mold frame MF, and a side surface of the fixing member 311c. The top chassis TC may include a first cover 933a configured to cover the upper surface of the first support 311a and a second cover 933b configured to cover the side surfaces of the first support 311a and fixing member 311c. A hook 425 may be disposed on an inner side of the second cover 933b and the hook 425 may be in contact with a lower surface of the fixing member 311c on the mold frame MF. The top chassis TC may be fixed to the mold frame ME by the hook 425.

The upper cover UCV may be configured to cover part of an upper side of the wavelength conversion unit 460. The upper cover UCV will be described in more detail below with reference to FIGS. 2, 3, and 5.

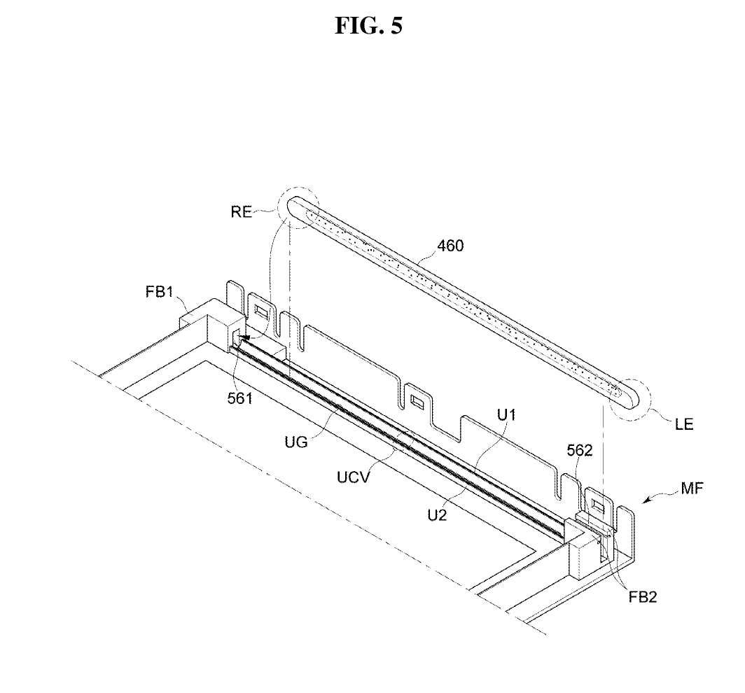

FIG. 5 is a diagram illustrating a rear surface of a mold frame including an upper cover UCV illustrated in FIGS. 1 and 2. FIG. 5 illustrates the mold frame MF rotated 180 degrees with respect to a right short side of the mold frame MF illustrated in FIG. 1.

The upper cover UCV, as illustrated in FIG. 2, may cover part of an upper side of the light incident surface F of the wavelength conversion unit 460. The upper side of the light incident surface F, as illustrated in FIG. 3, may refer to a part disposed higher than the central portion CC of the light incident surface F. The upper side of the light incident surface F may be disposed between the central portion CC and an upper boundary portion, and the upper boundary portion may refer to the boundary between the light incident surface F and the upper surface U. The part of the upper side of the light incident surface F disposed higher than the central portion CC may be part of the upper surface U. In an exemplary embodiment of the present inventive concept, the part of the upper side may be the first upper edge portion.

The upper cover UCV, as illustrated in FIGS. 2 and 5, may include a first upper protrusion U1 and a second upper protrusion U2, which may define an upper accommodating groove UG. The upper accommodating UG may be disposed between the first and second upper protrusions U1 and U2 facing each other.

The part of the upper side of the light incident surface F of the wavelength conversion unit 460 may be disposed in the upper accommodating groove UG, and thus the part of the upper side of the light incident surface F disposed in the accommodating groove UG may be covered by an inner wall of the upper accommodating groove UG. The inner wall of the upper accommodating groove UG may include facing surfaces of the first and second upper protrusions U1 and U2. The inner wall of the upper accommodating groove UG, as illustrated in FIG. 2, may be disposed between the first and second upper protrusions U1 and U2, and the inner wall may include a surface that connects the facing surfaces to each other.

Referring to FIGS. 2 and 3, the first upper edge portion of the light incident surface F may be covered by the inner wall of the upper accommodating groove UG. A partial surface that is adjacent to the first upper edge portion and disposed between the first upper edge portion and the central portion CC may be covered by the inner wall of the upper accommodating groove UG. The inner wall covering the first upper edge portion may have a rounded shape which may be similar to a shape of the first upper edge portion. The first upper edge portion and the partial surface may all belong to part of an upper side.

Referring to FIG. 2, upper edge portions of the upper surface U and the light emitting surface R may be covered by the inner wall of the upper accommodating groove UG. A partial surface that is adjacent to the second upper edge portion and disposed between the second upper edge portion and the central portion CC may be covered by the inner wall of the upper accommodating groove UG. The part covered with the inner wall of the upper accommodating groove UG may be in contact with the inner wall of the upper accommodating groove UG.

The upper cover UCV, as illustrated in FIG. 2, may be disposed on the mold frame MF. The upper cover UCV and the mold frame MF may be separately made, and may be coupled to each other.

The first lower protrusion L1 and the first upper protrusion U1 may be configured to direct where the light source (or the light sources) is (or are) disposed. The light source LS, as illustrated in FIG. 2 for example, may be disposed between the first lower protrusion L1 and the first upper protrusion U1. The first lower protrusion L1 and the first upper protrusion U1 may be in contact with the light source LS, and may reduce leakage of light from the light source LS. The second lower protrusion L2 and the second upper protrusion U2 may be configured to direct where the light guide plate LGP is disposed. The light guide plate LGP may be disposed between the second lower protrusion L2 and the second upper protrusion U2. An edge portion of the light guide plate LGP on which the light incident surface 122 is disposed may be disposed between the second lower protrusion L2 and the second upper protrusion U2. The second lower protrusion L2 and the second upper protrusion U2 may be in contact with the light guide plate LGP, and may reduce leakage of light from the wavelength conversion unit 460.

The mold frame MF, as illustrated in FIG. 5 for example, may include a first fixing part FB1 and a second fixing part FB2. The first fixing part FB1 and the second fixing part FB2 may be disposed on the mold frame MF.

The first and second fixing parts FB1 and FB2 may fix the wavelength conversion unit 460 to the mold frame MF and may direct where the light guide plate LGP and the optical sheet OS are disposed.

The first fixing part FB1 may be disposed at an end portion of the first and second upper protrusions U1 and U2. The first fixing part FB1 may fix a left side edge portion of the wavelength conversion unit 460 to the mold frame MF. The first fixing part FB1 may have a first fixing groove 561 that surrounds the left side edge portion of the wavelength conversion unit 460. An opening of the first fixing groove 561 may face the upper accommodating groove UG.

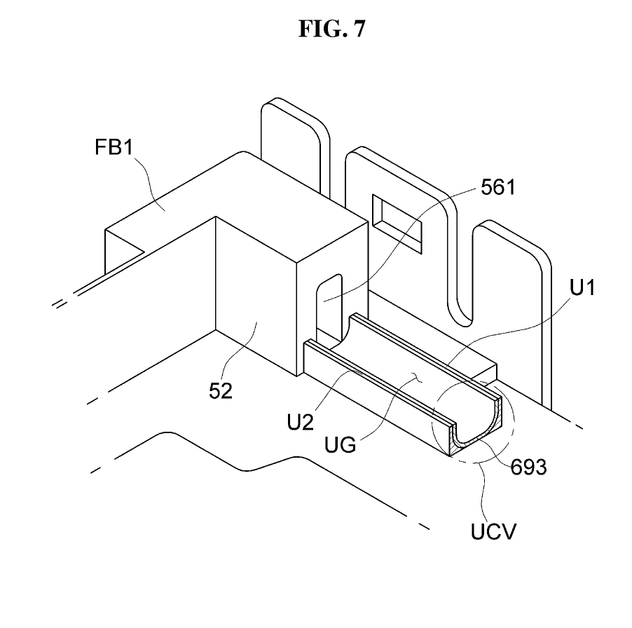

The first fixing part FB1 may include a first spacer wall 52 (see, e.g., FIG. 7). The first spacer wall 52 may be disposed between a right side edge portion of the wavelength conversion unit 460 and a right side edge portion of the light guide plate LGP, which may maintain the distance therebetween. Collisions between the light guide plate LGP and the wavelength conversion unit 460 may be reduced. In an exemplary embodiment of the present inventive concept, the first spacer wall 52 may be an external wall that faces the right side edge portion of the light guide plate LGP.

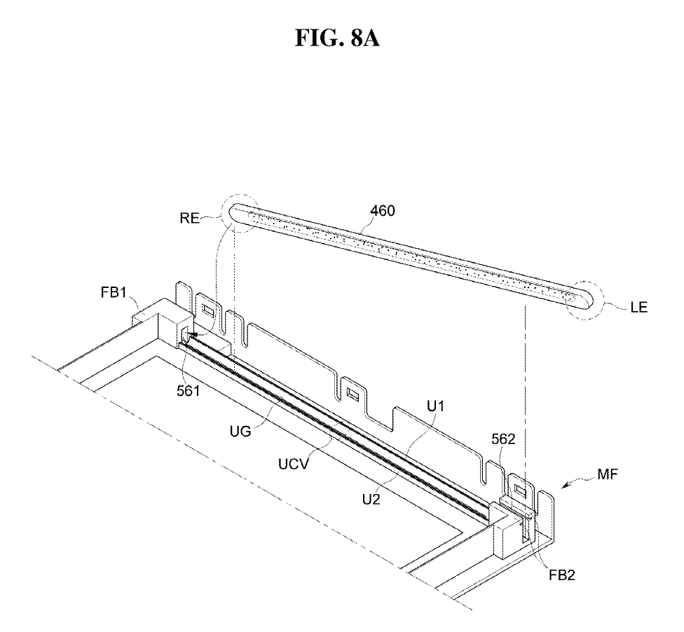

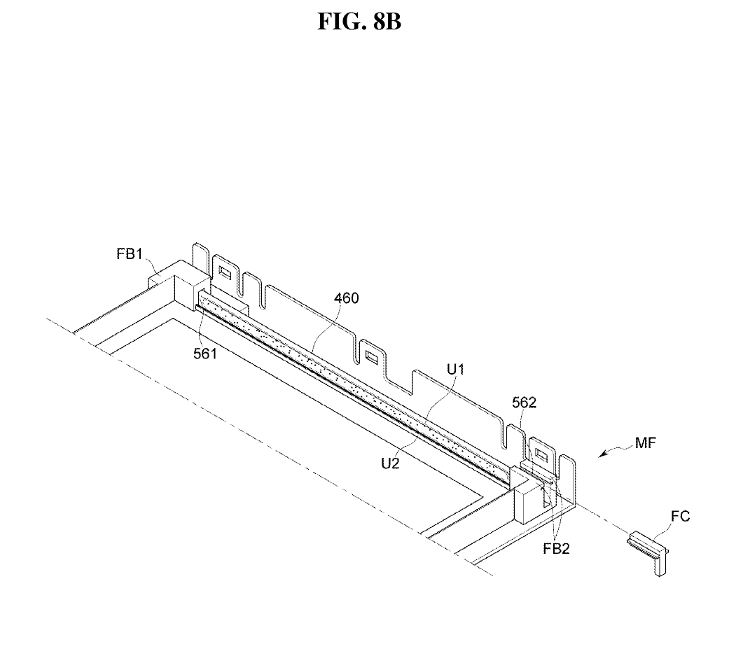

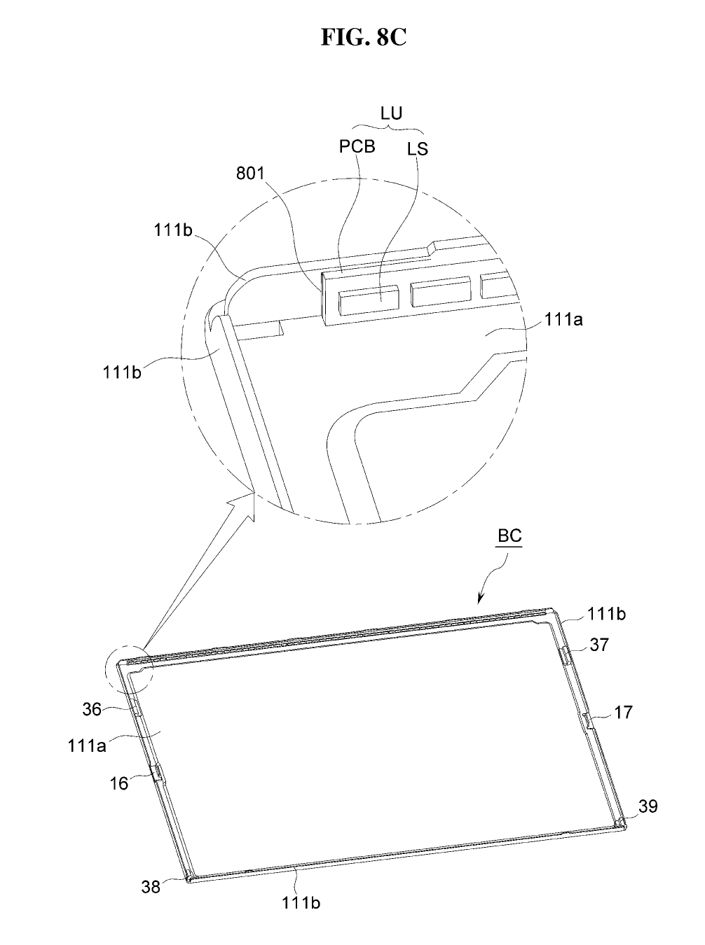

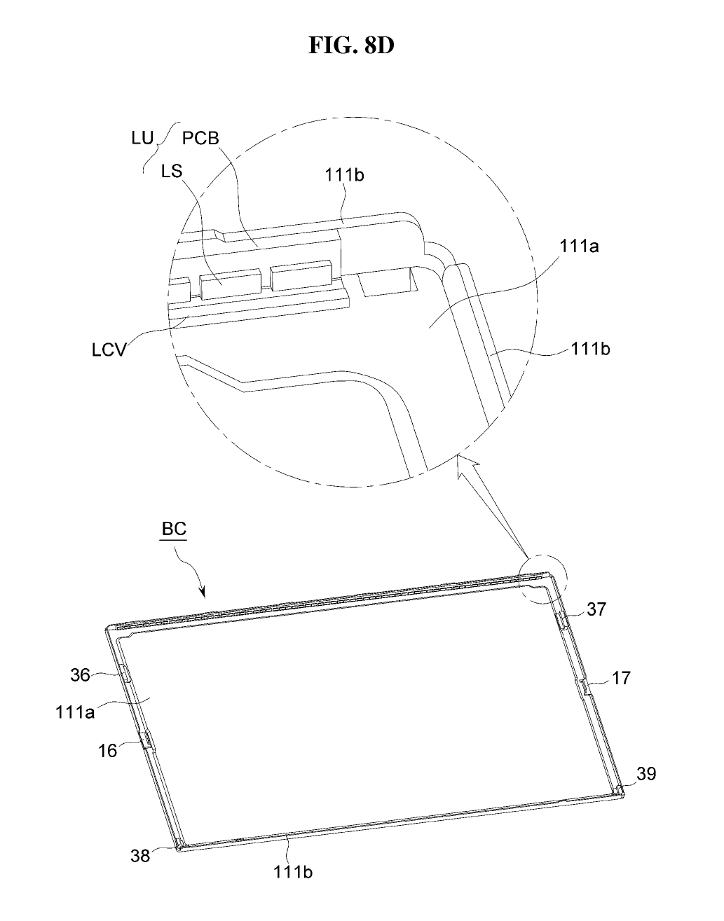

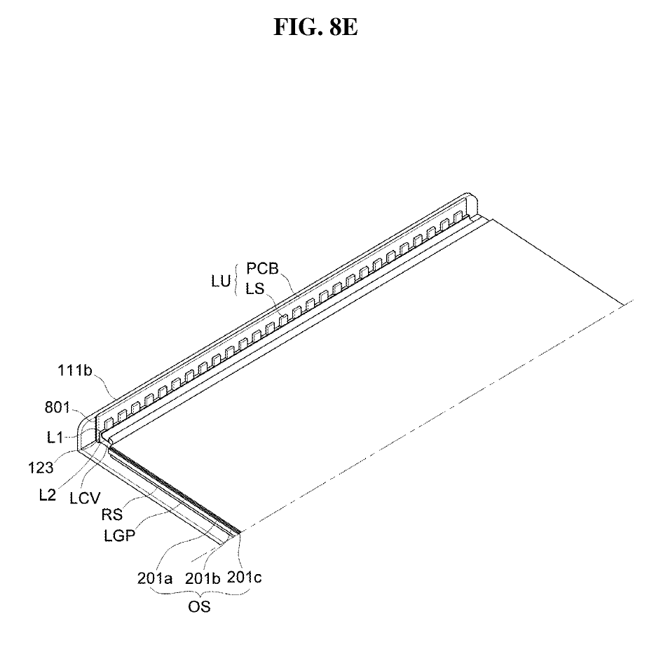

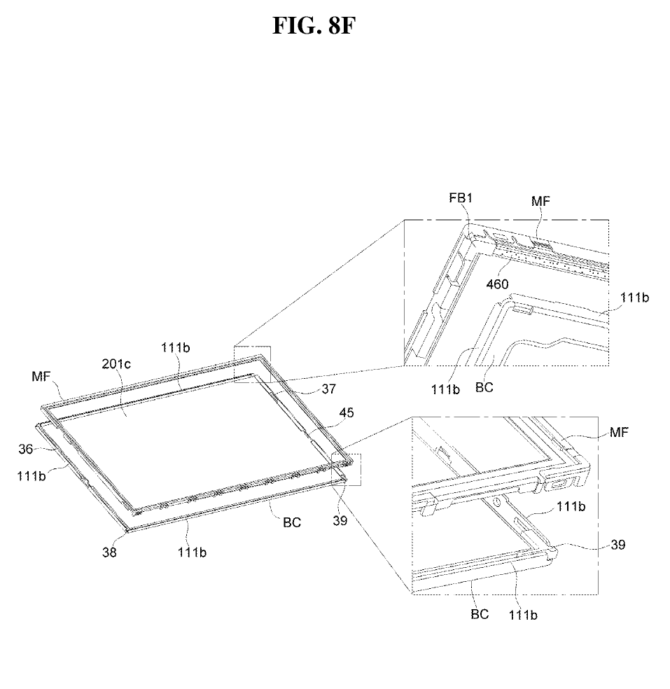

The second fixing part FB2 may be disposed at the other end portion of the first and second upper protrusions U1 and U2. The first and second fixing parts FB1 and FB2 may face each other with the first and second upper protrusions U1 and U2 disposed therebetween. The second fixing part FB2 may fix the left side edge portion of the wavelength conversion unit 460 to the mold frame MF. The second fixing part FB2 may have a second fixing groove 562 that surrounds part of the left side edge portion of the wavelength conversion unit 460. The first and second fixing grooves 561 and 562 may face each other with the first and second upper protrusions U1 and U2 disposed therebetween. The second fixing groove 562 may be coupled to a fixing cover FC (see, e.g., FIG. 8B), which may surround a part of the right side edge portion of the wavelength conversion unit 460 at a coupling portion of the second fixing groove 562. The fixing cover FC may be disposed in the coupling portion of the second fixing groove 562.

The second fixing part FB2 may include a second spacer wall 53 (see, e.g., FIG. 8B). The second spacer wall 53 may be disposed between the left side edge portion of the wavelength conversion unit 460 and a left side edge portion of the light guide plate LGP, which may maintain the distance therebetween. Collisions between the light guide plate LGP and the wavelength conversion unit 460 may be reduced. In an exemplary embodiment of the present inventive concept, the second spacer wall 53 may be an external wall that faces the left side edge portion of the light guide plate LGP.

The mold frame MF may include first and second supporting protrusions 66 and 67.

The first and second supporting protrusions 66 and 67 may be configured to substantially fix a position of the light guide plate LGP. The first supporting protrusion 66 may vertically protrude from the first fixing part FB1. The second supporting protrusion 67 may vertically protrude from the second fixing part FB2. The light guide plate LGP may be disposed between the first and second supporting protrusions 66 and 67.

The light incident surface 122 of the light guide plate LGP may protrude more than both side edge portions thereof toward the wavelength conversion unit 460.

The reflection sheet RS may have the same shape as the light guide plate LGP. The reflection sheet RS may be substantially fixed in a position by the first and second spacer walls 52 and 53 and by the first and second supporting protrusions 66 and 67.

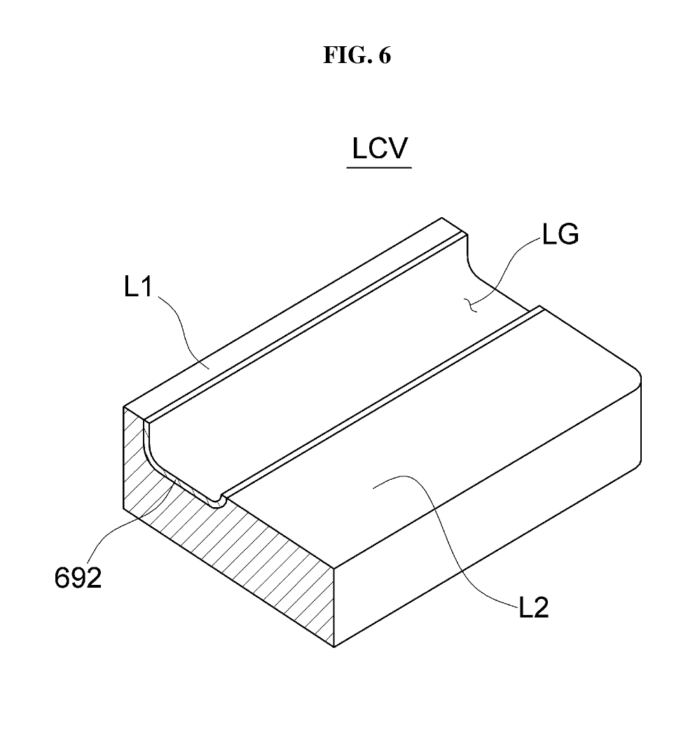

The lower cover LCV may include a reflection member 692 configured to reflect light and the reflection member 692 will be described in more detail below with reference to FIG. 6.

FIG. 6 is a diagram illustrating a reflection member of a lower cover.

As illustrated in FIG. 6, the reflection member 692 may be disposed on an internal wall of the lower accommodating groove LG. In an exemplary embodiment of the present inventive concept, the reflection member 692 may be disposed on a corresponding surface of the wavelength conversion unit 460, which may face the internal wall, and not on the internal wall of the lower accommodating groove LG. The reflection member 692 may be any one of a reflective tape, a white reflective tape, a white reflective tape including a phosphor, and a silver (Ag) reflective tape. In the white reflective tape including a phosphor, the phosphor may be a substance that converts blue light to white light.

The reflection member 692 may include a material having properties of specular reflection or diffuse reflection. For instance, the reflection member 692 may be any one of a reflective tape characterized by diffuse reflection, a white reflective tape characterized by diffuse reflection, a white reflective tape including a phosphor and characterized by diffuse reflection, and a silver (Ag) reflective tape characterized by diffuse reflection.

Although not illustrated, substantially the entire interior wall of the lower accommodating groove LG may be substantially covered with a material such as white paint. Substantially the entire interior wall of the lower accommodating groove LG may be substantially covered with the reflection member 692. The interior wall of the lower accommodating groove LG may be substantially covered with the white paint, and the reflection member 692 may be disposed on the white interior wall.

Although not illustrated, the lower cover LCV may include an elastic cushion member. The cushion member may be disposed on substantially the entire interior wall of the lower accommodating groove LG. The cushion member may include, for example, an elastic foam tape.

The lower cover LCV may include at least two of the reflection member 692, the white paint, and the cushion member. In an exemplary embodiment of the present inventive concept, the interior wall of the lower accommodating groove LG may be substantially covered with the white paint, the cushion member may be disposed on the white paint, and the reflection member 692 may be disposed on the cushion member.

The upper cover UCV may include a reflection member 693 and the reflection member 693 will be described in more detail below with reference to FIG. 7.

FIG. 7 is a diagram illustrating a reflection member of an upper cover.

As illustrated in FIG. 7, the reflection member 693 may be disposed on the interior wall of the upper accommodating groove UG. In an exemplary embodiment of the present inventive concept, the reflection member 693 may be disposed on a corresponding surface of the wavelength conversion unit 460, which may face the interior wall, and not on the interior wall of the upper accommodating groove UG. The reflection member 693 may be any one of a reflective tape, a white reflective tape, a white reflective tape including a phosphor, and a silver (Ag) reflective tape. In the white reflective tape including a phosphor, the phosphor may be a substance that converts blue light to white light.

The reflection member 693 may include a material having properties of specular reflection or diffuse reflection. For instance, the reflection member 693 may be any one of a reflective tape characterized by diffuse reflection, a white reflective tape characterized by diffuse reflection, a white reflective tape including a phosphor and characterized by diffuse reflection, and a silver (Ag) reflective tape characterized by diffuse reflection.

Although not illustrated, substantially the entire interior wall of the upper accommodating groove UG may be substantially covered with a material such as white paint. Substantially the entire interior wall of the upper accommodating groove UG may be substantially covered with the reflection member 693. The interior wall of the upper accommodating groove UG may be substantially covered with the white paint, and the reflection member 693 may be disposed on the white interior wall.

When the upper cover UCV is coupled to the mold frame MF, the interior wall of the upper accommodating groove UG may be substantially covered with the white paint as described above, and the entire mold frame MF may be substantially covered with black paint, except for the interior wall.

Although not illustrated, the upper cover UCV may include the elastic cushion member. The cushion member may be disposed on substantially the entire interior wall of the upper accommodating groove UG. The cushion member may include, for example, an elastic foam tape.

The upper cover UCV may include at least two of the reflection member 693, the white paint, and the cushion member. In an exemplary embodiment of the present inventive concept, the interior wall of the upper accommodating groove UG may be substantially covered with the white paint, the cushion member may be disposed on the white paint, and the reflection member 693 may be disposed on the cushion member.

Hereinafter, an assembly method of a backlight unit according to an exemplary embodiment of the present inventive concept will be described in more detail.

FIGS. 8A to 8F are diagrams illustrating an assembly process of a backlight unit according to an exemplary embodiment of the present inventive concept.

As illustrated in FIG. 8A, a mold frame MF that is overturned to expose an upper cover UCV may be prepared. The right side edge portion of a wavelength conversion unit 460 may be inserted into the first fixing groove 561, and the left side edge portion of the wavelength conversion unit 460 may be inserted into the second fixing groove 562. Part of the lower side of the wavelength conversion unit 460 may be disposed in the lower accommodating groove LG.

Next, as illustrated in FIG. 8B, a fixing cover FC may be slidably fitted into a coupling groove and the fixing cover FC may be firmly coupled to the coupling groove. Substantially the entire left side edge portion of the wavelength conversion unit 460 may be surrounded by the interior wall of the second fixing groove 562 and the fixing cover FC. An interior surface of the fixing cover FC may be in contact with the left side edge portion of the wavelength conversion unit 460 and the wavelength conversion unit 460 may be fixed to the mold frame MF.

As described above, the process of coupling the wavelength conversion unit 460 to the upper cover UCV may be performed with little or no friction between the wavelength conversion unit 460 and the upper cover UCV and the occurrence of damage to the wavelength conversion unit 460 may be reduced. Friction, which can occur when the coupling process is performed, may be confined to the left and right side edge portions of the wavelength conversion unit 460. The left and right side edge portions need not include the phosphor 460a, and damage to the wavelength conversion unit 460 may be reduced.

As illustrated in FIG. 8C, the light source unit LU may be attached to the side portion 111b of the bottom chassis BC. The light source unit LU may be coupled to the bottom chassis BC by an adhesive member 801 disposed between an interior surface of the side portion 111b and a surface of the printed circuit board PCB.

As illustrated in FIG. 8D, a lower cover LCV may be coupled to the light source unit LU. The lower cover LCV may be coupled to the light source unit LU by an adhesive member disposed between the lower cover LCV and the surface of the printed circuit board PCB.

As illustrated in FIG. 8E, the reflection sheet RS may be disposed on the second lower protrusion L2 of the lower cover LCV and a central portion of the bottom chassis BC. The light guide plate LGP, the diffusion sheet 201a, the prism sheet 201b, and the protective sheet 201c may be sequentially disposed on the reflection sheet RS. As illustrated in FIG. 8F, both side edge portions and vertex portions of the reflection sheet RS, the light guide plate LGP, the diffusion sheet 201a, the prism sheet 201b, and the protective sheet 201c may be disposed on first to fourth supports 36, 37, 38, and 39. FIG. 8F includes enlarged views illustrating two edge portions and one view of the two enlarged views, which illustrates one edge portion including the wavelength conversion unit 460, seen from a rear surface of the bottom chassis BC.

As illustrated in FIG. 8F, the mold frame MF may be coupled to the bottom chassis BC. Part of a lower side of the wavelength conversion unit 460 fixed to the mold frame MF may be covered with the lower cover LCV fixed to the bottom chassis BC.

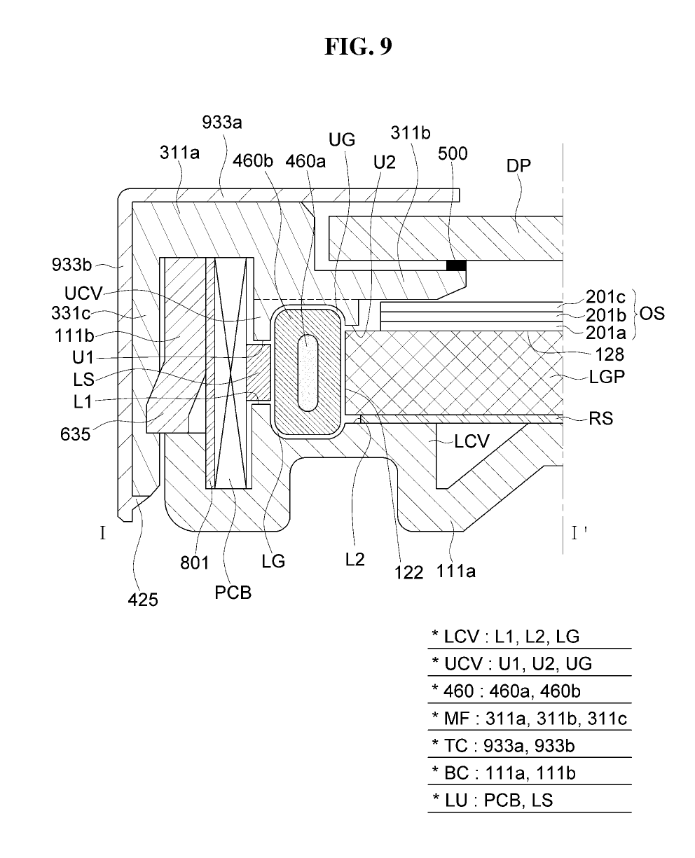

The lower cover LCV may be coupled to the bottom chassis BC. An exemplary embodiment of the lower cover LCV will be described in more detail below with reference to FIG. 9.

FIG. 9 is a diagram illustrating a lower cover integrated with on a bottom chassis.

As illustrated in FIG. 9, part of the bottom chassis BC may be shaped like the lower cover LCV. Parts of the bottom chassis BC may have shapes that correspond to the first lower protrusion L1, the second lower protrusion L2, and the lower accommodating groove LG. The lower cover LCV may be fixed to the bottom chassis BC without the adhesive member.

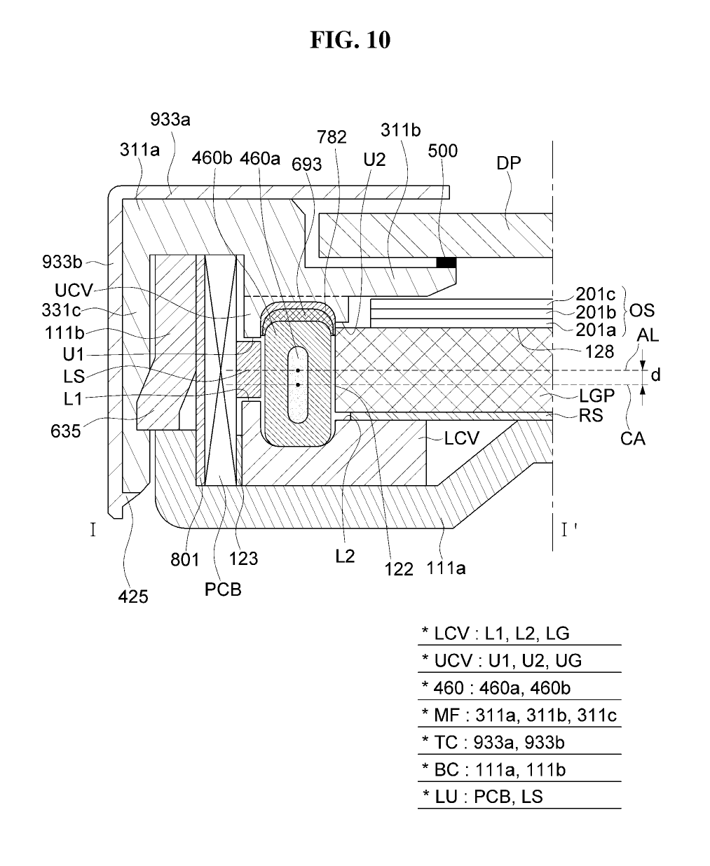

Light leakage in the light incident surface 122 may be reduced according to where the wavelength conversion unit 460 is disposed in the backlight unit, and positions of the wavelength conversion unit 460 will be described in more detail below with reference to FIG. 10.

FIG. 10 is a diagram illustrating a change of a location in which the wavelength conversion unit 460 is disposed.

Referring to FIG. 10, an imaginary line may connect a point of the light source LS, in which light emission occurs, and a central portion of the light incident surface 122 of the light guide plate LGP. The imaginary line may be referred to as an alignment line AL. A central axis CA of the wavelength conversion unit 460 may be disposed lower than the alignment line AL in a direction of the lower cover LCV. In an exemplary embodiment of the present inventive concept, the wavelength conversion unit 460 may be disposed lower such that the central axis CA of the wavelength conversion unit 460 may be about 0.3 mm lower than the alignment line AL. A distance “d” of FIG. 10 may represent a distance between the central axis CA of the wavelength conversion unit 460 and the alignment line AL. The distance d may be about 0.3 mm.

In this case, the phosphor 460a of the wavelength conversion unit 460 may be disposed lower than the light source LS compared to the previous embodiment. Therefore, light directed towards a lower side of the light source LS of light emitted from the light source LS may pass through the phosphor 460a. Light directed towards an upper side of the light source LS of the light emitted from the light source LS may fail to pass through the phosphor 460a. The light that fails to pass through the phosphor 460a may be reflected by the reflection member 693 disposed on the interior wall of the upper accommodating groove UG and may pass through the phosphor 460a. When the reflection member 693 has properties of diffuse reflection, not specular reflection, more light can pass through the phosphor 460a. The white reflective tape including the phosphor 460a may be included in the reflection member 693. The reflection member 693 may convert blue light to whit light using its own phosphor 460a, and thus a relatively larger amount of light may be converted into white light. As a cushion member 782, a foam tape may be disposed between the reflection member 693 and the interior wall of the upper accommodating groove UG.

According to an exemplary embodiment of the present inventive concept illustrated, for example, in FIG. 10, effects resulting from the change in location of the wavelength conversion unit 460 may be increased and side effects caused by the location change may be reduced using the reflection sheet 693, and light leakage may be reduced. In order to minimize the light leakage in the absence of the change in location of the wavelength conversion unit 460, the reflection members 692 and 693 (e.g., the white reflective tape including the phosphor) may be disposed on all of the interior walls of the upper and lower accommodating grooves UG and LG disposed in the upper and lower sides of the light sources LS. The location where the wavelength conversion unit 460 is disposed may be changed to reduce light leakage.

Although not illustrated, even when the central axis CA of the wavelength conversion unit 460 is disposed higher than the alignment line AL in a direction of the upper cover UCV, light leakage may still be reduced. The reflection member 692 may be disposed on the interior wall of the lower accommodating groove LG, and not on the upper accommodating groove UG.

The location where the wavelength conversion unit 460 is disposed, as described with reference to FIG. 10 above, may be applied to all of the exemplary embodiments of the present inventive concept described above.

The location of the central axis CA of the wavelength conversion unit 460 may be substantially the same as that of the central portion CC of the light incident surface F or the light emitting surface R of the wavelength conversion unit 460.

While the present inventive concept has been shown and described with reference to the exemplary embodiments thereof, it will be apparent to those of ordinary skill in the art that various changes in form and detail may be made thereto without departing from the spirit and scope of the inventive concept.

What is claimed is:

1. A backlight unit comprising:
at least one light source configured to emit light;
a light guide plate comprising a light incident surface and a light emitting surface, wherein the light from the light source is incident on the light incident surface and the incident light is emitted through the light emitting surface;
a wavelength conversion unit disposed between the light source and the light incident surface of the light guide plate;
a lower cover configured to cover at least part of a lower portion of a light incident surface of the wavelength conversion unit; and
an upper cover configured to cover at least part of an upper portion of the light incident surface of the wavelength conversion unit.

2. The backlight unit of claim 1, wherein the lower cover comprises first and second lower protrusions, and wherein a lower surface of the wavelength conversion unit is disposed in a lower accommodating groove defined by the first and second lower protrusions.

3. The backlight unit of claim 1, wherein at least one of the upper and lower covers is configured to cover at least part of a light emitting surface of the wavelength conversion unit.

4. The backlight unit of claim 1, wherein the wavelength conversion unit comprises:
a glass container; and
a phosphor disposed in the glass container.

5. The backlight unit of claim 4, wherein the phosphor is disposed higher than the light source.

6. The backlight unit of claim 4, wherein the phosphor comprises a quantum dot.

7. The backlight unit of claim 2, further comprising a reflection member disposed between the lower accommodating groove and the wavelength conversion unit.

8. The backlight unit of claim 7, wherein the reflection member comprises a phosphor or silver (Ag).

9. The backlight unit of claim 2, further comprising a cushion member disposed between the lower accommodating groove and the wavelength conversion unit.

10. The backlight unit of claim 1, wherein the upper cover comprises first and second upper protrusions, and wherein an upper surface of the wavelength conversion unit is disposed in an upper accommodating groove defined by the first and second upper protrusions.

11. The backlight unit of claim 10, further comprising a reflection member disposed between the upper accommodating groove and the wavelength conversion unit.

12. The backlight unit of claim 11, wherein the reflection member comprises a phosphor or silver (Ag).

13. The backlight unit of claim 8, further comprising a cushion member disposed between the upper accommodating groove and the wavelength conversion unit.

14. The backlight unit of claim 1, further comprising a fixing part configured to fix at least one end portion of the wavelength conversion unit.

15. The backlight unit of claim 14, further comprising a mold frame configured to define a place in which the light guide plate and an optical sheet are installed,
wherein the mold frame is coupled to the fixing part.

16. The backlight unit of claim 14, wherein the fixing part comprises:
a first fixing part having a first fixing groove in which a first side end portion of the wavelength conversion unit is disposed;
a second fixing part having a second fixing groove in which a second side end portion of the wavelength conversion unit is disposed; and
a fixing cover coupled to at least one of the first and second fixing parts.

17. The backlight unit of claim 16, wherein the fixing cover covers at least one side end portion of the wavelength conversion unit.

18. The backlight unit of claim 1, wherein the lower cover is integrated with a bottom chassis.

19. The backlight unit of claim 1, wherein the upper cover is integrated with the mold frame.

20. The backlight unit of claim 1, wherein a location of a central axis of the wavelength conversion unit is different from a location of an alignment line that connects a point of the light source with a central portion of the light incident surface of the light guide plate.

21. A backlight unit, comprising:
one or more light sources configured to emit light;
an upper cover comprising a first upper protrusion and a second upper protrusion forming an upper accommodating groove therebetween;
a lower cover comprising a first lower protrusion and a second lower protrusion forming a lower accommodating groove therebetween;
a wavelength conversion member configured to convert a wavelength of light emitted from the one or more light sources, wherein an upper portion of the wavelength conversion member is partially disposed in the upper accommodating groove, and wherein a lower portion of the wavelength conversion member is partially disposed in the lower accommodating groove; and
a light guide plate disposed between the second upper protrusion and the second lower protrusion.

22. The backlight unit of claim 21, wherein the one or more light sources are disposed between the first lower protrusion and the first upper protrusion.

23. The backlight unit of claim 21, wherein the light guide plate comprises a light incident surface facing the wavelength conversion member;

24. The backlight unit of claim 21, wherein the wavelength conversion member comprises a glass container and a phosphor disposed in the glass container.
